(19) United States
(12) Patent Application Publication
(10) Pub. No.: US 2008/0249207 A1
(43) Pub. Date: Oct. 9, 2008

(54) Safety Coatings

(75) Inventors: Reginald Keith Whiteley, New South Wales (AU); Marilyn Emily Karaman, New South Wales (AU)

Correspondence Address: PRYOR CASHMAN, LLP, 410 PARK AVENUE, NEW YORK, NY, 10022, US

(73) Assignee: WHITELEY CORPORATION PTY LTD, North Sydney, NSW (AU)

(21) Appl. No.: 12/092,341

(22) PCT Filed: May 2, 2007
(86) PCT No.: PCT/AU07/00566

§ 371 Date: May 1, 2008

(30) Foreign Application Priority Data
May 2, 2006 (AU) 2006902267

(51) Int. Cl. C09D 5/14; C08L 91/06; C08G 59/00; C08G 63/00; C08G 18/00

(52) U.S. Cl. 523/122; 525/50; 524/500; 524/275; 525/55; 525/403; 525/418; 525/452; 524/502

(57) ABSTRACT

The invention relates to coating compositions, in particular anti-slip floor coating compositions that contain a crystalline polymeric material in solution that crystallises as the coating cures leading to the formation of hard polymeric crystals within the cured coating composition. The invention also relates to methods of making these compositions and uses thereof.

### FIELD OF THE INVENTION

The present invention relates generally to coating compositions and methods of making and applying the same. In particular the invention relates to anti-slip floor coating compositions that contain a crystalline polymeric material in solution that crystallises as the coating cures leading to the formation of hard polymeric crystals within the cured coating composition. It is found that the presence of these hard crystals in the final cured coating composition leads to improved anti-slip properties in comparison to analogous compositions that do not contain the crystalline polymeric composition.

### BACKGROUND OF THE INVENTION

The coating of floors with floor coating compositions is well known in the art. Coatings have been applied to floors to impart a number of desirable characteristics to the final coated floor. As such coatings may be applied as protective agents for the floor to stop the floor becoming marked, as sealers to stop moisture or other spills from penetrating the floor or to provide a desirable visual appearance to the finished floor. For example coatings may be applied to provide a protective coating to the floor in order to ensure that the floor is not unduly worn by regular foot traffic and the like. Alternatively a coating composition may be provided to act as a sealant to the floor such that any liquid spills do not damage the floor but rather are kept on the surface where they can easily be safely removed. In many of these applications the floor to be coated is located in an environment where a visually desirable appearance is required such as in a shopping centre or a hospital environment. Accordingly in many instances a floor coating composition that can impart a high shine or gloss is used. As such in these applications it is common that such flooring is coated with high gloss floor polishes and/or sealers, which are typically of an essentially acrylic origin.

Unfortunately there are two competing requirements presented when floors of this type are desired namely aesthetic appearance versus safety of the final floor. In essence in order to provide an aesthetic appearance to the floor the industry has turned to the use of high gloss finishes that are shiny and are typically very smooth and visually attractive. These surfaces, whilst aesthetically very pleasing to the eye of the public, tend to be slippery especially when they become contaminated with liquids or other solid debris. One problem that is therefore associated with conventional surface finish compositions that provide a gloss finish is their relatively low safety factor due to their tendency to be or become slippery when wet. As a result, floors that are coated with high gloss conventional surface finish compositions may be the cause of frequent slip and fall accidents. Slip and fall accidents, in turn, bring about increased liability costs and higher insurance premiums for the operators of public spaces where the accidents occur.

Improving the performance characteristics, especially the safety, of these floor surfaces which are subject to heavy, regular human foot traffic continues to present practical difficulties, particularly in large shopping malls and retail establishments. The seemingly ever increasing incidence of slips and falls by the public in these areas poses continuing and very costly problems with personal safety and public liability insurance, world wide.

While international and national standards exist to define the level of safety, for example Australian/New Zealand AS/NZS 4663:2002, manufacturers of floor coating chemicals have continuing difficulty in meeting such standards, especially when flooring becomes wet either through wetting or accidental spillage of chemical products on sale. This applies equally to solvent based and water based (emulsion) coatings of all common types.

As a result of the size of the potential market there have been a number of attempts to find a satisfactory solution to these problems. Anti-slip coatings thus far marketed internationally are now comprised of hard solid particles—usually finely ground plastic resin particles—dispersed within acrylic and modified acrylic coating solutions or dispersions. While possessing much increased slip resistance, measured by recognized published standard methods, these particle containing coatings have a much reduced level of appearance (gloss) compared with normal contemporary floor polishes and are, accordingly, totally unacceptable for use in large retail shopping areas and shopping malls where the aesthetic properties of the coated floor are important.

It would therefore be desirable to develop floor coating compositions that exhibited acceptable anti-slip properties whilst at the same time do not reduce the gloss levels of the coated floor to a visually unacceptable level.

### SUMMARY OF THE INVENTION

The present invention provides an aqueous based floor coating composition including a base polymeric material, a crystalline polymeric material, a surfactant, and a solvent for the crystalline polymeric material, wherein the crystalline polymeric material is dissolved in the composition and recrystallises within the coating on drying. The composition is such that after it is applied to a surface the composition gradually dries whereby the volatile components of the composition such as water and any other volatile ingredients evaporate progressively leaving the solid components as a film or coating on the floor. The applicants have found that the final coating contains crystals of the crystalline polymeric material which are typically relatively uniformly dispersed throughout the coating or film. Without wishing to be bound by theory, it is believed that as the water evaporates, the base polymeric material particles come closer and closer together, and the crystalline polymeric material in the solvent anchors to the base polymeric material particles residing at the interface. An extended crystalline polymeric material network forms, bridging to other base polymeric material particles. As the solvent system dynamics change within the interface, the crystalline polymeric material becomes increasingly more insoluble ultimately causing the crystalline polymeric material to crystallize macroscopically, capped by the base polymeric material in a uniform manner across the sealer surface. Whilst the exact point of formation of the crystals will depend upon the crystalline polymeric material chosen this typically leads to portions of crystalline polymeric material being cohesively bonded by portions of amorphous polymeric material.

The compositions of the invention may include any of a number of additives well known in the art for compositions of this type. Examples of suitable additives that may be considered include biocides, defoamers, plasticizers, surfactants, wax emulsions, brightening agents, fragrances, buffing agents, polar coalescing agents, stabilisers, polyethylene and polypropylene waxes, odour suppressers and soil resistance agents.

In yet an even further aspect the invention provides a method of making an aqueous based floor coating composition including the steps of:

(a) providing an emulsion of a base polymeric material in water;
(b) dissolving a crystalline polymeric material in a solvent to provide a solution of the crystalline polymeric material;
(c) mixing the solution of crystalline polymeric material produced in step (b) with the emulsion of base polymeric material provided in step (a), wherein the mixing is conducted for a period of time and in a manner to produce a homogeneous composition.

In yet another aspect of the invention there is provided a method of improving the anti-slip properties of a floor coating composition, which method includes mixing a solution of a crystalline polymeric material in a solvent with the floor coating composition. In this embodiment, the solution of the crystalline polymeric material may be slowly added to a ready-made floor coating or floor sealer composition. The floor coating composition may be a commercially available composition, or a ready-made aqueous based floor coating composition.

The aqueous based coating compositions of the invention have also been found to have applications in other areas, where anti-slip, high drag altered surface characteristics are required.

The base polymeric material used in the compositions and methods of the invention may be of any suitable type typically used in floor coating compositions. A skilled worker in the field would be readily aware of the type of polymeric materials that may be used and the exact polymeric material chosen will depend upon the end use application and the properties that are desired in the final coating composition. Typically, the base polymeric material is a polymer formed from polymerisation of ethylenically unsaturated monomers. In one embodiment, the base polymeric material is selected from the group consisting of an acrylic, modified acrylic, urethane, styrene, alkylstyrene, stilbene polymer or copolymer, and mixtures thereof. Examples of such acrylic polymers or acrylic copolymers are those produced by polymerisation of one or more monomer units selected from the groups consisting of methyl methacrylate, methyl acrylate, hydroxy methyl acrylate, ethyl acrylate, hydroxy ethyl acrylate, propyl acrylate, hydroxy propyl acrylate, isopropyl acrylate, butyl acrylate, isobutyl acrylate, acrylic acid, methacrylic acid, phosphoethyl acrylate and 2 ethyl hexyl acrylate, and styrene and other polymerisable derivatives thereof. In another embodiment the acrylic polymer or acrylic copolymer is cross-linked.

In another specific embodiment of the invention the base polymeric material includes a poly urethane. Any suitable poly urethane may be used as would be well known to a skilled addressee in the area.

The amount of base polymeric material used in the compositions and methods of the invention will depend upon the desired end use application and can vary greatly. It is typically found, however, that the base polymeric material is present in an amount of from about 2 to 90 wt % of the total weight of the aqueous based floor coating composition. In another embodiment the base polymeric material is present in an amount of from about 5 to 60 wt % of the total weight of the aqueous based floor coating composition. In yet another embodiment the base polymeric material is present in an amount of from about 10 to 50 wt % of the total weight of the aqueous based floor coating composition. In one embodiment the base polymeric material is present in an amount of from 20 wt % to 40 wt % of the total weight of the aqueous based floor coating composition.

The crystalline polymeric material used in the compositions and methods of the invention is chosen to provide crystals in the final dried coating that have the desired performance characteristic such as size, durability, hardness, refraction, and the like. The choice of crystalline polymeric material is also made depending upon the identity of the base polymeric material. Typically the crystalline polymeric material is chosen such that it is chemically compatible with the base polymeric material. In one embodiment the base polymeric material and the crystalline polymeric material are miscible. In another embodiment the base polymeric material and the crystalline polymeric material have a similar refractive index. In yet another embodiment the base polymeric material and the crystalline polymeric material are capable of cohesive interactions, such as hydrogen bonding, such that there is an attraction between the backbone of the base polymeric material and the backbone of the crystalline polymeric material.

The crystalline polymeric material is typically selected from the group consisting of acrylic polymers, methylate polymers, poly acrylic polymers, epoxy polymers, polycarbonate polymers, polyester polymers, polystyrene polymers, poly vinyl polymers, and polyurethanes or composites, derivatives or graft copolymers thereof.

The size of the polymer chains in the crystalline polymeric material may vary greatly with the length of chain (and hence the molecular weight) of the crystalline polymeric material being chosen such that upon drying the crystals produced have sufficient size and hardness to impart the desired performance characteristics on the final film. Generally, the molecular weight of the polymer chains of the crystalline polymeric material fall in the range from 1000 to 200 000. For example, in one embodiment the crystalline polymeric material has a molecular weight of about 10 000, whereas in another embodiment the crystalline polymeric material has a molecular weight of about 50 000.

In one embodiment the crystalline polymeric material includes poly(methyl methacrylate). In another embodiment the crystalline polymeric material includes a polyurethane.

The amount of crystalline polymeric material used in the compositions and methods of the invention may vary widely and will depend upon the level of crystals desired to be present in the finished or dried coating/film. There is a balance however as there is a requirement for there to be sufficient crystals in order to impart the desired anti-slip, (high drag) characteristics to the coating/film. However if the level of crystal formation is too high then this will lead to a less visually attractive surface finish (lower gloss). In one embodiment the crystalline polymeric material is present in an amount of from 0.1 to 20 wt % based on the total weight of the aqueous based floor coating composition. In another embodiment the crystalline polymeric material is present in an amount of from 1 to 10 wt % based on the total weight of the aqueous based floor coating composition.

A solvent for the crystalline polymeric material is used in the compositions and methods of the present invention.

The composition of the invention includes a solvent for the dissolution of the crystalline polymeric material. This ensures the crystalline polymeric material is in solution within the composition. Once again without wishing to be bound by theory it is felt that it is desirable to ensure that the crystalline polymeric material remains in solution (ie homogeneous) until application of the composition to the floor as it is felt that this ensures that the crystals are uniformly distributed throughout the film/coating.

The choice of solvent will be determined based on the identity of the crystalline polymeric material used in the compositions of the invention. In addition the solvent must not hinder the drying and film formation process of the aqueous based floor coating composition of the invention. Accordingly the appropriate solvent to be used can be readily determined by a skilled addressee once the crystalline polymeric material has been chosen. The solvent may be a single chemical species (such as a pure solvent) or it may be a mixture of chemical species (to produce a mixed solvent). In one embodiment the solvent for the crystalline polymeric material is an organic solvent. In one embodiment the organic solvent is selected from the group consisting of (but not limited to) methyl acetate, ethyl acetate, propyl acetate, isopropyl acetate, butyl acetate, pentyl acetate, butanol, hexanol, hexyl acetate; cyclohexanol, n-methylpyrrolidone, pyrrolidone, cyclohexanone, cyclohexyl acetate, benzyl alcohol, benzaldehyde, benzyl acetate, dichlorobenzylalcohol; ethylene glycol; propyl, butyl and hexyl mono and diglycols and their methyl, ethyl esters and acetates; methyl, ethyl and propyl lactate and citrates; phthalate methyl, ethyl and butyl esters, tributyl ethoxy phosphate; dipentene, terpineol; methyl ketone, amyl ketone, di isobutyl ketone, amyl acetate, isobutyl acrylate, tetrahydrofuran and mixtures thereof.

The amount of solvent used will be readily determined by the particular crystalline polymeric material chosen and the desired rate of crystallisation of the crystalline polymeric material in use. Nevertheless the solvent is typically present in an amount of from 0.5 to 20 wt % of the total weight of the aqueous based floor coating composition. In another embodiment the solvent is present in an amount of 0.5 to 10 wt % of the total weight of the aqueous based floor coating composition.

In yet an even further aspect the invention provides a method of coating a floor the method including applying a composition of the invention as described herein.

The composition of the invention has been found to be very versatile. It can be easily coated on both porous and non porous surfaces producing a surface having acceptable anti-slip properties and at the same time having a visually acceptable gloss level. The anti-slip surface produced, even though glossy, can be subsequently coated with other high gloss floor polishes to enhance the gloss even further, without impairing the anti-slip qualities of the composition of the invention.

In one embodiment of the invention, the composition is easily removed with conventional strippers, allowing the coated surfaces to be routinely maintained by stripping and resealing. In cases where a more permanent anti-slip seal is required, the composition of the invention may be formulated to form a more permanent sealer which does not require regular stripping and recoating, but still maintaining the anti-slip properties.

Tests on the composition of the invention show it to be stable on storage. For example, product prepared 12 months prior was still found to be homogeneous and when applied to a vinyl tile surface produced a glossy, rough surface similar to that produced at the time of manufacture.

Although the composition of the invention is typically formulated as a floor coating, the physical properties of the composition mean that is may be well suited to other applications where an anti-slip, high drag, rough surface is required. For example the composition of the invention may be useful when applied to high traffic surfaces, handling surfaces, tire surfaces, marine surfaces, surf board surfaces, air traffic surfaces, aircraft surfaces, automotive surfaces and footware and leather goods surfaces, where anti-slip, high drag, altered surface characteristics are desirable. If applied to aircraft or marine surface it may impart desirable aerodynamic characteristics (eg altering the wind and viscous drag characteristics). The composition of the invention may also have many uses in military applications, for example in military aircraft and military marine applications.

Accordingly, there is provided according to a further aspect of the invention a method of improving anti-slip properties of a surface by applying to said surface an aqueous based coating composition including a base polymeric material, a crystalline polymeric material, a surfactant, and a solvent for the crystalline polymeric material, wherein the crystalline polymeric material is dissolved in the composition and recrystallises within the coating on drying. In this embodiment, the surface may be selected from a high traffic surface, handling surface, tire surface, marine surface, surf board surface, air traffic surface, aircraft surface, automotive surfaces, footware surface and leather good surface. The composition of the invention may be provided in the form of a paint.

There is provided according to yet a further aspect of the invention, the use in a military application, to improve anti-slip properties of a surface, of an aqueous based coating composition including a base polymeric material, a crystalline polymeric material, a surfactant, and a solvent for the crystalline polymeric material, wherein the crystalline polymeric material is dissolved in the composition and recrystallises within the coating on drying.

### BRIEF DESCRIPTION OF THE FIGURES

FIG. 1A shows a light microscope photograph of one embodiment of the composition of the invention, applied to a vinyl floor tile substrate. FIG. 1B shows a comparison with the pattern akin to that employed on safety flooring metal work.

FIG. 2 shows light microscopy photographs under 6× magnification for different embodiments of the composition of the invention, applied to a vinyl floor tile substrate.

FIG. 3 shows light microscopy photographs under 10×, 16×, 25× and 40× magnification for a composition of one embodiment of the invention, applied to a vinyl floor tile substrate.

FIG. 4 shows light microscopy photographs under 10×, 16×, 25× and 40× magnification for a composition of another embodiment of the invention, applied to a vinyl floor tile substrate.

FIG. 5A shows an Atomic Force Microscopy image of yet another embodiment of the invention applied to a vinyl floor tile over scan area 10 μm×10 μm. FIG. 5B shows an Atomic Force Microscopy image of this embodiment of the invention over scan area 5 μm×5 μm.

FIG. 6 shows an enlarged view of the image of FIG. 5B.

### DETAILED DESCRIPTION OF INVENTION

The products of this invention are based on the ability to modify the film structure deposited by existing emulsion polymers; and indeed most commercial high gloss, durable floor polishes and sealers. This is achieved by crystallising compatible crystalline polymeric materials within the coating film as it dries to yield a homogeneous transparent gloss dry film that maintains, if not increases, the gloss, durability and wear characteristics of the primary or base polymer system, whilst still retaining the non-slip characteristics of the base polymer system; and which can be recoated either with normal floor polish or by reapplication of the aqueous based floor coating composition of the invention.

The present applicants commenced their study of anti-slip coatings and included studies of the physical nature of emulsion and aqueous dispersion floor sealers and polishes employing atomic force microscopy. By adding together two or more polymers, one containing a crystalline structure or backbone, it was found that when these were dispersed in another acrylic or urethane polymeric emulsion, a homogenous solution resulted. It was found that upon drying larger crystallite structures were formed at the interface during the drying process which were physically (ie chemically) bound within the polymer matrix forming a rough but uniform surface coating. The particles were noted to form at the interface where these crystals are present as the solution evaporates and the coating is formed. The invention was demonstrated on a variety of surfaces.

This coating was observed to be both uniform and reproducible. The kinetics of crystalline development were investigated and the level of roughness was also examined using an atomic force microscope (AFM). The size and distribution of the crystals have the effect of increasing the coefficient of friction of the applied surface coating when measured using the wet slip methods described in AS/NZS 4663:2002. Testing on a range of surfaces, both porous and non-porous confirmed the reproducibility of the outcome and findings of the invention.

On further testing of the surface coating, using an acrylic system, it was also found that the surface could be both maintained (i.e. re-coatable) and removed easily (strippable). Different coatings could be applied either underneath or over the invention without removing the non-slip characteristic. This has major maintenance benefits for coatings applied as floor finishes. On the other hand, if a more permanent coating is required (non-strippable), the composition of the invention may be formulated to form a more permanent coating which does not require regular stripping and recoating but still maintaining the anti-slip properties.

Similar observations on urethane based sealers and polishes showed a generally more integral and continuous surface on drying; which undoubtedly accounts for the high level of gloss, toughness and water resistance of these coatings compared to emulsion acrylic coatings. It can thus be confirmed visually that the addition of a crystalline polymeric material to a base polymeric material yields a floor coating with improved physical properties.

Based on these observations the present applicants deduced that under the correct conditions it should be possible to “grow” crystals within coating compositions such as acrylic coatings, possibly of a size sufficient to alter dramatically the Coefficient of Friction (CoF) of a dried sealer surface leading to improved anti-slip properties. It was also deduced that the size of the crystals could be controlled according to the final requirements for the coating, such as a floor coating, for example wear, gloss and anti-slip characteristics.

### Base Polymeric Materials Used in the Present Invention

There are a number of base polymeric materials that have found application as the polymeric component of floor coating compositions. Examples of suitable polymeric materials that have found application in floor coating compositions include polymers based on acrylate, methacrylate, urethane and styrene monomers. Indeed the range of base polymeric materials that are useful in these applications would be well known to a skilled addressee.

Nevertheless floor coating compositions typically fall into two categories namely:
(a) Water emulsion finishes for use in flexible vinyl flooring which traditionally have been based on acrylic emulsion polymers that can be removed (stripped) and replaced when worn by foot traffic.
(b) Water based emulsion or dispersed type urethane finishes, which are more recent in origin, and are normally used for hard, durable high gloss non-replaceable finishes such as wood parquetry floors and ceramic surfaces.

Solvent based versions of both acrylic and urethane type polymers are also widely used in a large range of permanent and semi-permanent sealers and finishes for use on multiple surfaces; and are the more traditional technologies involved in both groups of resinous floor finishes. More recently polyester based materials have come into use for very durable paint finishes such as employed on new motor vehicles.

Aqueous floor finishes for high volume foot traffic normally are based on acrylic or modified acrylic polymers. Urethanes that are either water soluble or dispersible or emulsion type are increasingly in use as more durable, stand alone finishes.

Products based on mixtures of water based acrylic and urethane polymers are emerging in attempt to achieve the better properties of both polymer groups, in particular in durability as semi-permanent sealers and finishes that can be stripped and replaced if required. However, each of the current groups of polymers employed in manufacture of floor finishes suffer from low coefficient of friction (especially on wet surfaces) and present serious potential of slips and falls by pedestrians under normal use conditions.

The compositions of the present invention can be based on any of the known floor coating compositions and the base polymeric material used in any of these known compositions can be used as the base polymeric material of the compositions of the present invention.

Typically, the base polymeric material is a polymer formed from polymerisation of ethylenically unsaturated monomers. In one embodiment, the base polymeric material is selected from a polymer or copolymer produced from acrylic, modified acrylic, styrene, alkylstyrene, stilbene and/or urethane monomers, and mixtures thereof. There are a number of acrylic polymers or copolymers well known in the art that may be used. In one embodiment the acrylic polymer or acrylic copolymer is essentially derived from polymerization of one or more monomer units selected from the group consisting of methyl methacrylate, methyl acrylate, hydroxy methyl acrylate, hydroxy ethyl acrylate, ethyl acrylate, butyl acrylate, isopropyl acrylate, isobutyl acrylate, propyl acrylate, hydroxy propyl acrylate, isopropyl acrylate, acrylic acid, methacrylic acid, phosphoethyl acrylate and 2-ethyl hexyl acrylate, and styrene and other derivatives thereof. The polymer or copolymer may be cross linked, including metal ion cross linking, to provide greater structural integrity and which may provide enhanced strippability, and polymers and copolymers of this type are well known and commercially available.

In another embodiment suitable commercially-available acrylic emulsion co-polymers which may be used as the base polymeric material in the compositions and methods of the present invention include, but are not limited to, co-polymers produced from one or more of the following monomers: acrylic acid, butyl acrylate, ethyl acrylate, methyl acrylate, 2-ethyl hexyl acrylate (2-EHA), acrylonitrile, acrylamide, methacrylic acid, methyl methacrylate, ethyl methacrylate, butyl methacrylate, methacrylamide, and the like. Particularly suitable commercially-available acrylic co-polymers, for purposes of the present invention, include, but are not limited to, hydroxy ethyl acrylate, methyl methacrylate/butyl acrylate/methacrylic acid (i.e., MMA/BA/MAA) co-polymer, methyl methacrylate/butyl acrylate/acrylic acid (i.e., MMA/BA/AA) co-polymer, and the like.

Another such polymeric material, which may be used as the base polymeric material in the methods and compositions of the present invention are referred to in the art as a “styrene-acrylic co-polymers”. Suitable commercially-available styrene-acrylic co-polymers, for purposes of the present invention, include, but are not limited to, co-polymers produced from one or more of the following monomers: styrene, alpha-methyl styrene, and the like. Particularly suitable commercially-available styrene-acrylic co-polymers, for purposes of the present invention, include, but are not limited to, styrene/methyl methacrylate/butyl acrylate/methacrylic acid (i.e., S/MMA/BA/MAA) co-polymer, styrene/methyl methacrylate/butyl acrylate/acrylic acid (i.e., S/MMA/BA/AA) co-polymer, and the like.

Another polymeric material that may be present in the base polymeric material of the invention are polymeric materials based on stilbenes and substituted stilbenes.

In one specific embodiment the base polymeric material is cross linked to provide added strength and stability to the final floor coating. An example of such a cross linked polymeric material is described in U.S. Pat. No. 7,009,006 which relates to a modified acrylic polymer. This patent describes a cross linked polymeric composition comprising; (a) copolymer particles having first phosphoric acid groups (b) polycarbodiimide; (c) an aqueous medium, and (d) at least one phosphoric acid compound having at least one second phosphorus acid group; wherein the ratio of equivalents of the second phosphorus acid groups to equivalent of the first phosphoric acid groups is between 0 and 2. This leads to a final acrylic resin whereby the functional groups on the resin cross link to produce an interconnected polymer matrix.

In general the present invention applies to any polymeric base material that can be used in floor coating compositions. It is found however that it is particularly applicable to acrylic polymers, mixtures of acrylic with other polymer types, to modified acrylic polymers (eg polymers with grafted side chains, cross linked polymers etc) and to most forms of low to moderate molecular weight urethane polymers in the nominal range of 500 to 20 000 monomer units, being suitable for use as surface coatings. These polymeric materials may be produced using any technique well known in the art although they are conveniently manufactured either by thermally induced emulsion or solvent based polymerization assisted by either mechanical stirring at moderate or ultra fast speeds, high pressure turbulent mixing, ultrasonic or other means of mixing that efficiently promote the reactions involved.

### Manufacture of Acrylic Polymers

The acrylic polymeric materials that may be used in the present invention may be produced in any way known in the art. The reader is directed toward the seminal reference text “Emulsion Polymerisation: a mechanistic approach; Robert. G. Gilbert, 1995, Academic Press, UK, which elucidates in minute theoretical and practical detail the science involved in emulsion polymerization, and as such describes most commercial manufacturing methods for manufacturing emulsion based products of this type.

Details of the various acrylate monomers employed in manufacture of floor type coatings are provided in commercial product literature available from Rohm & Hass Inc., USA, and several other international chemical companies. A skilled worker in the field would be readily able to produce a number of acrylic polymers or acrylic copolymers based on what is readily known in the art.

### Urethane Polymers

If a urethane polymer is used in the composition of the present invention it may be made using any technique known in the art. Urethane polymers are typically formed by thermal condensation reactions between a very wide range of derivatives of poly isocyanates and polyols. The literature describes many such polymers some of which have been adapted to use in surface and floor coatings Patent literature describes a large number of formulations and methods of manufacture, including means of converting freshly condensed urethane-based polymers into either water soluble, water dispersible and/or aqueous emulsions.

### The Crystalline Polymeric Materials

Any crystalline polymeric material well known in the art may be used as the crystalline polymeric material for use in the compositions and methods of the present invention. The only requirement is that upon drying of the composition by evaporation of the solvent the crystalline polymeric material forms, whereby hard crystalline particles of polymeric material are typically relatively uniformly distributed throughout the film or coating. Typically, when materials of this type crystallise they only partially crystallise such that they form regions of crystalline material joined or linked by amorphous regions of the polymer backbone. Suitable crystalline polymeric materials that may be used in the invention include, but are not limited to, acrylic polymers, poly acrylic polymers, epoxy polymers, polycarbonate polymers, polyester polymers, polystyrene polymers, poly vinyl polymers, polyurethanes and composites, derivatives, branched and graft copolymers thereof which can be solubilised within appropriate solvents of the nature described herein.

In order to yield maximum crystal hardness the highest molecular weight polymer in a chemically compatible group should be employed. Generally, the molecular weight of the polymer chains of the crystalline polymeric material fall in the range of from 1000 to 200 000. For example, in one embodiment the crystalline polymeric material has a molecular weight of about 50 000, whereas in another embodiment the crystalline polymeric material has a molecular weight of about 100 000. In the case of polycarbonate a molecular weight in excess of 1000 is generally found desirable. Other crystalline polymeric materials of an essentially polar nature but having molecular weights in the general range but not limited to 1000 to 200 000 monomer units can also be employed. It is a simple experiment to determine suitability of particular crystalline polymeric materials. The principles already outlined will serve as a guide to evaluating alternative crystalline resins.

### The Solvent for the Crystalline Polymeric Material

A number of solvents may be used for the crystalline polymeric material and the choice of solvent is typically predicated on the identity of the crystalline polymeric material. The solvent chosen must be compatible with other solvent(s) employed in the coating composition, allowing predicted behaviour to occur without detriment to the properties of a particular formulation. It must also be capable of dissolving the crystalline polymeric material to ensure that the particles formed in the coating are produced during the curing of the composition after application and must not hinder the drying process and film formation process.

The solvent may be of any suitable type and may be a single chemical species (a pure solvent) or a mixture of chemical species (a mixed solvent). In general in order to be compatible with the polymeric materials used in the invention the solvent will be an organic solvent. Any of a number of organic solvents may be used, for example, but not limited to, methyl acetate, n-methylpyrrodinone, pyrrolidone, ethyl acetate, propyl acetate, isopropyl acetate, butyl acetate, pentyl acetate, butanol, hexanol, hexyl acetate; cyclohexanol, cyclohexanone, cyclo-hexyl acetate, benzyl alcohol, benzyl aldehyde, benzyl acetate, dichlorobenzylalcohol; ethylene glycol; propyl, butyl and hexyl mono and diglycols and their methyl, ethyl esters and acetates; methyl, ethyl and propyl lactate and citrates; phthalate methyl, ethyl and butyl esters, tributyl ethoxy phosphate; dipentene, terpineol; methyl ketone, amyl ketone, di isobutyl ketone, amyl acetate, isobutyl acrylate; tetrahydrofuran and mixtures thereof.

The amount of solvent is typically chosen to ensure adequate dissolution of the crystalline polymeric material and to ensure that the crystalline polymeric material does not crystallise until the drying process begins. Nevertheless the amount of solvent is typically from 0.5 to 20 wt % of the weight of the aqueous based floor coating composition. In another embodiment, the solvent is present in an amount of 0.5 to 10 wt % of the total weight of the aqueous based floor coating composition.

### Surfactants Used in the Compositions of the Present Invention

The compositions of the present invention include a surface active agent (surfactant) that serves to emulsify the base polymeric material and form an emulsion of the base polymeric material in water. Any of a number of well known surfactants may be used in the compositions of the present invention. The choice of surfactant is based on the identity of the base polymeric material being emulsified. A wide variety of surfactants can be used and the surfactants can be non-ionic, cationic, zwitterionic and amphoteric either used alone or in combination with each other.

Examples of suitable non-ionic surfactants include alcohol ethoxylates such as C₈ to C₁₈ alcohol ethoxylates containing from about 3 to 50 moles of ethylene oxide per molecule; C₈ to C₁₈ fatty acid esters and amides containing from about 2 to 50 moles of ethylene oxide; C₈ to C₁₈ fatty alcohols; C₈ to C₁₈ diols such as tetramethyl decynediol and dimethyl octynediol; block copolymers of polyethylene oxide and polypropylene oxide; C₈ to C₁₈ fatty acid esters of glycerine; ethoxylated and propoxylated C₈ to C₁₈ fatty alcohols; C₈ to C₁₈ fatty amine and amidoamine oxides; C₈ to C₁₈ fatty amides and alkanolamides; and alkyl saccharides (e.g., alkyl glucosides); nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”), polysorbate surfactants (e.g., polyoxyethylene ethers), polysorbate and phenoxypolyethoxyethanols and sodium salt of ethoxylated sulfated alcohols.

A further useful class of non-ionic surfactant are the amine oxides, such as the C₁₀-C₂₀-alkyl-di(lower)alkyl-amine oxides or the C₁₀-C₂₀-alkylamino(C₂₋₅)alkyl di(lower)alkyl-amine oxides. Especially preferred members of this class include lauryl(dimethyl)amine oxide, myristyl(dimethyl)amine oxide, stearyl(dimethyl)amine oxide (Schercamox® DMS, Scher Chemicals, Inc., Clifton, N.J.), coco(bis-hydroxyethyl)amine oxide (Schercamox® CMS), tallow(bis-hydroxyethyl)amine oxide, cocoamidopropyl amine oxide and cocoamidopropyl(dimethyl)amine oxide (Schercamox® C-AA). Another useful class of nonionic surfactant is the silicone-glycol copolymers. These surfactants are prepared by adding poly(lower)alkylenoxy chains to the free hydroxyl groups of dimethylpolysiloxanols and are available from the Dow Corning Corp as Dow Corning 190 and 193 surfactants (CTFA name: dimethicone copolyol.).

Other useful non-ionics include the ethylene oxide esters of polyoxyethylene thio ether, the ethylene oxide esters of fatty acids such as the lauric ester of polyethylene glycol and the lauric ester of ethoxypolyethylene glycol, the ethylene oxide ethers of fatty acid amides, the condensation products of ethylene oxide with partial fatty acid esters of sorbitol such as the lauric ester of sorbitan polyethylene glycol ether, and other similar materials, wherein the mole ratio of ethylene oxide to the acid, phenol, amide or alcohol is about 5-50:1.

Another suitable class of surfactant include amphoteric surfactants. Preferred amphoteric detergents are the amine oxides, such as the C₁₀-C₂₀-alkyl-di(lower)alkyl-amine oxides or the [C₁₀-C₂₀-alkylamido(C₂-C₅)alkyl](lower)alkyl-amine oxides. Especially preferred members of this class include lauryl(dimethyl)amine oxide, myristyl(dimethyl)amine oxide, stearyl(dimethyl)amine oxide (Schercamox DMS, Scher Chemicals, Inc., Clifton, N.J.), coco(bis-hydroxyethyl)amine oxide (Schercamox CMS), tallow(bis-hydroxyethyl)amine oxide, Dihydroxyethyl cocoamine oxide (Schercamox CMA) and cocamidopropyl(dimethyl)amine oxide(Schercamox C-AA).

In one embodiment, the surfactant is an anionic or non-ionic surfactant, or a combination thereof. The amount of surfactant used in the compositions of the present invention may vary although they are typically present in an amount of from 0.005 to 1 wt % of the aqueous based floor coating composition.

### Other Additives that May be Included in the Compositions of the Invention

The compositions of the present invention may also include a number of other additives well known in compositions of this type.

A brightening resin may be added to the composition. A brightening resin will assist in adding luster to the final polished coating. A typically used brightening resin is selected from the group consisting of a rosin adduct, an acrylic resin and a styrene/maleic anhydride resin. In one embodiment, a modified gum such as a gum rosin-modified maleic resin is used. This modified gum is compatible with a wide range of acyclic and styrene copolymers commonly used in floor coating compositions.

An agent which improves the buffing properties of the final coating may also be included. A wide variety of synthetic and naturally occurring buffing agents may be used, however, the most popular types are oxidised polyethylenes and polyethylene copolymers. Such agents are well known in the art and include polyethylene dispersions such as a polyethylene/polypropylene wax.

In some embodiments the compositions may include a coalescent agent to assist in the curing of the composition and the formation of the crystals of the crystalline polymeric material and in the deposition of the base polymeric material. The coalescent agent may be of any suitable type and will readily be chosen based on the identity of the base polymeric material and the crystalline polymeric material. Examples of suitable coalescent agents include diethylene glycol monomethylether, diethylene glycol monopropyl ether, diethylene glycol ethyl ether or a mixture thereof. The amount of coalescent agent may vary widely although if it is used it is typically present in an amount of about 4 to about 8 weight percent of the aqueous based coating composition.

The compositions of the present invention may include one or more plasticisers. The plasticiser can be any additive that softens the film or coating that is formed when the composition of the invention is applied to a surface, such as a floor surface, and allowed to dry. These plasticizers provide the final cured films or coatings with enhanced flexibility and formability characteristics. Any of a number of well known plasticisers may be used with examples of such plasticisers including tributoxyethyl phosphate, butyl benzyl phthalate, dimethyl phthalate, dibutyl phthalate, triphenyl phosphate and tributyl phosphate. Mixtures of two or more of these plasticisers can also be used. The amount of plasticiser may vary but is typically present in an amount of from 1 wt % to 20 wt %.

The compositions of the invention may also include a wetting agent. The wetting agent may be of any suitable type as would be clear to a skilled addressee. An example of a suitable wetting agent is potassium fluoroalkyl carboxylate available commercially as FC 129™ from The 3M Company, St Paul, Minn. It is used in an amount varying from about 0.5 to about 2 weight percent, based on the total weight of the final composition. The presence of a wetting agent is desirable as it tends to have a levelling effect on the film as it is applied leading to the formation of an even film application to the surface.

The compositions of the present invention may also include a biocide. Any of a number of suitable biocides that can be incorporated into coating compositions, in particular floor coating compositions, may be used with a skilled addressee readily able to determine a suitable biocide for the desired end use application. One suitable class of biocides that may be used in the present invention are nitrogen containing biocides (such as Kathon™ CG (methylisothiazolinone)). In principle any nitrogen containing or other compatible biocides that exhibits a biocidal effect against microorganisms may be included in the compositions of the present invention. The nitrogen containing biocide may or may not also act as a surfactant in the composition. In a preferred embodiment, the composition of the invention includes at least one nitrogen containing biocide.

Further examples of suitable biocides include methyl bisthiocyanate, betabromo betanitrostyrene, tetrachloro isonaphalonitrile, 2-bromo-2-nitro-1,3-propanol, 5-chloro-4-isothiazolin-3-one, 2-methyl-4-isothiazolin-3-one, 3,4-chlorophenyl-3,4 dichlorophenyl urea and Triclosan™ (5 chloro-2,4 dichlorophenoxy phenol).

A specific example of a suitable biocide (preservative) that may be used in the compositions of the present invention is a mixture of 5-chloro-methyl-isothiazialone-3-one with 2-methyl-4-isothiazialone-3-one. This biocide is available commercially as Kathon™ from Rohm & Haas, Philadelphia, Pa. The inclusion of a biocide helps protect the composition from bacterial and fungal microbes.

If a biocide is present the composition of the invention, typically includes at an amount from 0.025% to 2% by weight of the final composition. In one embodiment the amount of biocide is from 0.05% to 1% by weight of the final composition. In another embodiment the biocide is present in an amount of 0.1% to 0.2% by weight of the total weight of the composition.

The compositions of the present invention may also include a defoamer. The defoaming agent can be any defoaming agent that inhibits the development of foam when the inventive composition is mixed. The inclusion of a small amount of defoamer, usually from about 0.01 to about 0.03 weight percent, based on the total weight of the final composition helps break away any bubbles that may be formed during preparation of the composition of this invention. Many defoaming agents are known. See, for example, McCutcheon's “Functional Materials,” 1992, North American Edition, pp. 91-114, these pages being incorporated herein by reference. In one embodiment the defoaming agent is a dimethyl polysiloxane compound. Specific examples of antifoam agents are SWS 211 ™, SWS-213™ and SWS-214™ available from Wacker Silicones Corporation of Adrian Mich.

The compositions of the present invention may also include soil resisting polymers to restrict the rate of soiling of the cured film as well as to provide for easier, quicker, more complete routine cleaning maintenance, particularly in a biological context.

In addition to the possible additives mentioned above the compositions of the present invention may include any other additive well known in the art that may be incorporated into compositions of the types contemplated, such as stabilizers.

The selection of possible additional additives for use in the compositions of the present invention must be carried out judiciously in order to ensure that the additives chosen do not compromise the functional performance of the final composition. The additives must therefore be chosen such that their behaviour in the formulation does not diminish the basic design characteristics of the fully formulated coating.

### Manufacture of the Compositions of the Present Invention

The manufacture of the compositions of the present invention typically involves a multi step process. The first step (“step a”) typically involves preparing an emulsion of a base polymeric material in water. The second step (“step b”) typically involves preparing a solution of a crystalline polymeric material in a solvent.

Step a: An emulsion of the base polymeric material in water is typically prepared by adding all of the ingredients except the base polymeric material to water and agitating the mixture. Once a homogeneous dispersion has been produced the base polymeric material is added to the dispersion base with mixing to form an emulsion of the base polymeric material in water. Alternatively the base polymeric material and a surfactant may be added to water to form an emulsion of the base polymeric material in water. Following the formation of the emulsion any other additives that are desired to be present in the composition may be added to produce a final product of the base polymeric material in water containing all the required additives. Irrespective of the route chosen the final emulsion identical.

Step b: The crystalline polymeric material is then dissolved in a solvent to form a solution of the crystalline polymeric material. The solution is typically a clear non-viscous solution and is typically allowed to age for 24 hours prior to use. Without wishing to be bound by it is thought that aging is desirable in order to ensure that the solution is a stable solution.

Step c: In order to produce the final composition the solution of crystalline polymeric material is typically slowly added into the dispersion of base polymeric material in water with agitation. The mixture is typically agitated at moderate speed and allowed to mix until such time as a homogeneous composition is formed. This may take a period of time although it is typical that the mixing takes from 20 minutes to 120 minutes with about 30 minutes being found to be particularly suitable. The homogeneous composition is then typically aged for two hours and is then ready for application.

In another embodiment, the solution of the crystalline polymeric material may be typically slowly added to a ready-made floor coating composition. The floor coating composition may be a commercially available composition, or a ready-made aqueous based floor coating composition. For example, when a poly(methyl methacrylate) resin in butyl acetate is added to a laboratory-manufactured floor coating composition, and the resulting composition is applied to a surface, surface crystallites are formed leaving a glossy, uniform, rough surface. Upon the continuous laying down of further coats, an extremely rough, uniform, textured surface results.

### Application of the Coating Compositions of the Invention

The compositions of the present invention can be applied to surface, for example a floor surface, using any technique well known in the art and a skilled addressee can readily choose a suitable technique based on the composition to be applied and the site of application. Thus for example they can be applied by rolling, mopping, pouring, spraying or wiping the coating composition onto and over a surface to be coated. The exact mode of application will depend upon the site of application of the composition with different techniques being employed for a small area in comparison to a larger area.

After application, the coating composition is allowed to dry to touch resulting in the applied composition forming a hardened and slip resistant coating over the surface. The time required for the coating composition to dry will depend upon the solvent system used but is typically approximately 20 to 60 minutes. The coating composition may be applied as a single coating or may be applied as a series of successive coatings to form a thicker coating layer. Accordingly after a first coat of the composition has dried, a second coat can be applied in similar manner to form a multilayer coating.

Once laid in a heavy traffic area, using contemporary laying methods, the product is typically maintained by daily (or as required) wet mopping of scrubbing using a very soft polishing pad. Routinely it may be either recoated and or repaired by reapplication of the composition of the invention. Hardness and durability of the basic polish polymer and that of the grown crystals will determine the frequency with which a floor surface can be burnished to restore appearance; this involving use of a soft (non-abrasive) polishing pad, a technique well appreciated by experienced floor repairers. If required the surface can be stripped and re-laid in conventional manner using an approved stripping formulation. An advantage of the composition of the present invention is that it is re-coatable and can be applied to a surface generally without impacting on gloss levels. Furthermore, when the coating on the surface has dried, it can be coated with another high gloss polish, thus allowing the gloss to be improved further without an adverse effect on the anti-slip nature of the surface.

After application of the coating composition to a surface it is believed that a normal coalescing process occurs during drying of the composition, (once applied to a hard surface) as loss of solvent by evaporation or absorption into semi-porous substrates progressively allowing the long chain portion of the crystalline polymeric material to restore itself to a crystalline state that is firmly bound into and part of the surface of the dispersed base polymeric material. The crystals so formed are integral, continuous and uniformly dispersed throughout the drying film; and provide a roughened surface which does not significantly reduce the normal reflectivity of the base polymeric material used in the floor coating composition.

The rate of formation, the size and therefore the distribution of crystals is readily controlled by variation of the relative concentration of each polymer component, the concentration and type of the otherwise crystalline polymeric material in a particular solvent, the choice of the crystalline polymeric material, the choice of the solvent used to solubilise the crystalline polymeric material and the balance of coalescent solvents and plasticizer (if any) present in the composition.

The addition to or incorporation of poly isocyanurate based urethane polymers as aqueous dispersions in smaller amounts may allow crystallization to proceed but at rates specific to the formulating and related variables. All such reactions should occur at ambient temperature.

The roughness and uniform nature of surfaces coated with the composition of the invention, makes it well suited to use as an anti-slip floor sealer for wet areas (eg hospitality, back of house operations). In addition, the composition of the invention may have other applications, for example, high traffic surfaces, handling surfaces, tire surfaces, marine surfaces, surf board surfaces, air traffic surfaces, aircraft surfaces, automotive surfaces and footware and leather goods surfaces, where anti-slip, high drag, altered surface characteristics may be desirable. If applied to aircraft or marine surface it may impart desirable aerodynamic characteristics (eg altering the wind and viscous drag characteristics). The composition of the invention may also have many uses in military applications, for example in military aircraft and military marine applications.

As is well appreciated by those skilled in the art the nature, distribution and potential reactivity of possible functional groups on the outer layer of emulsion formed polymer particles formed will vary according to the following variables:
Monomer mix and proportion of each monomer in the mix
Type and proportion of acid groups on the polymer
Type and distribution of hydroxyl or related groups
Whether the polymer latex is prepared by one, two, three or more consecutive reaction steps as in core polymers.
Molecular weight of the polymer or polymer mix employed in polish or sealer compositions
Nature of the solvent mix in a polish formulation
Surfactants employed in the reaction mix(es).
Specialty solvents included to facilitate, regulate or promote crystallization during drying.
The presence or absence of additional cross-linking agents

The affect of these variables can readily be established by simple bench experiment, when the rate of formation and the ultimate crystal size can be seen macroscopically or visually. The exact shape and size of crystals and the spacing between particles formed as a film dries is readily determined microscopically. Ideally crystal size will be sufficient to extend vertically above the bulk of the dried polish film, but the optimum and appropriate crystal size will be determined by actual test of surface friction. By varying the choice of the base polymeric material, the crystalline polymeric material, the solvents and additives in the aqueous based coating composition, a composition specifically adapted for the situation in which is it to be used can be produced.

More specifically, it was found that the type of base polymer has a large impact on surface texture and roughness. It is possible to vary the texture of the surface and Coefficient of Friction (CoF) by varying the base polymer and solvent system. By varying the base polymer the surface texture can be varied from an extremely large textured surface to a fine textured surface to no texturing at all.

The Stanley Pendulum wet slip test procedure is the internationally approved instrument for wet slip testing of organic and inorganic floor coatings. A CoF reading in excess of 0.6 is required to satisfy most approval regimes is readily found by simple experiment as described above. By these means a high quality appearance floor can be achieved and quite simply maintained with a CoF in excess of 0.60, the desired minimum for commercial flooring in high traffic public building areas under wet and dry conditions.

The invention will now be described with reference to the accompanying examples.

### EXAMPLE 1

### Acrylic Polish Composition

A basic Dry-Brite™ acrylic polish composition was formed containing the ingredients listed in Table I.

TABLE I

| Ingredient | Amount (kg) | |
|---|---|---|
| Demineralised water | 338.3 | kg |
| Kathon CG ™ biocide | 0.5 | |
| Fluorad FSA ™ surfactant | 10.0 | |
| Defoamer SWS211 ™ | 0.2 | |
| Diethyleneglycol ethylether | 75.0 | |
| Dibutyl phthalate | 10.0 | |
| Tributoxyethylphosphate | 15.0 | |
| Duraplus 3 ™ (Rohm & Haas) | 435.0 | |
| Resinal 812 ™ (15% ammonical) | 40.0 | |
| Michem emulsion 39325 ™ (Polyethylene | 86.0 | |
| emulsion 30%) | | |
| TOTAL | 1000.0 | kg |

Duraplus ™ is a modified acrylic polymer.

A solution of a crystalline polymeric material was formed using the ingredients listed in Table II.

TABLE II

| Ingredient | Amount (kg) |
|---|---|
| Lucite 47G 80/100 ™ | 15.0 |
| Ethyl lactate | 85.0 |
| Total | 100.0 |

Lucite 47G ™ is a solid acrylic resin made by Lucite International Ltd.

The final floor coating composition was prepared by blending 95 grams of the composition of Table I with 5 grams of the solution of Table II to produce a homogeneous floor coating composition

The blending involved the slow addition of the solution of Table II to the agitated composition of Table I at room temperature with moderate shear for 30 minutes. Stand for 2 hours before use.

### EXAMPLE 2

### Aqueous Acrylic-Urethane Floor Coating

A basic urethane composition was formed containing the ingredients listed in Table III.

TABLE III

| Ingredient | Amount (g) |
|---|---|
| Demineralised water | 480 |
| 1% Fluorad FC129 ™ | 12 |
| Dow Corning Q2-1614 ™ | 0.5 |
| Dowanol DPM ™ | 24 |
| Propyleneglycol | 14 |
| Dowanol PM ™ | 42 |
| Dibutylphthalate | 24 |
| Tributoxyethylphosphate | 12 |
| Kathon CG-ICP 11 ™ | 1.5 |
| Primal 2133 ™ (Rohm & Haas) | 390 |
| TOTAL | 1000 |

Primal 2133 ™ is an modified acrylic polymer emulsion designed for heavy duty floor sealing.

A solution of a crystalline polymeric material was formed using the ingredients listed in Table IV.

TABLE IV

| Ingredient | Amount (g) |
|---|---|
| Beckothane M21 ™ (Nuplex) | 35.0 |
| n-methyl pyrrolidone | 35.0 |
| hexyl acetate | 30.0 |
| Total | 100.0 |

The final floor coating composition was prepared by blending 87 grams of the composition of Table III with 13 grams of the solution of Table IV to produce a homogeneous floor coating composition

The blending involved the slow addition of the solution of Table IV to the agitated composition of Table III at room temperature with moderate shear for 30 minutes. Stand for 2 hours before use.

### EXAMPLE 3

### Urethane Floor Coating

A basic urethane composition was formed containing the ingredients listed in Table V (Part A) followed by a solution of a crystalline polymeric material containing the ingredients listed in Table VI (Part B).

TABLE V

| Ingredient | Amount (g) |
|---|---|
| Demineralised water | 120.0 |
| Kathon CG ™ | 0.10 |
| Zonyl FSA ™ | 1.0 |
| Antifoam SWS 211 ™ | 0.05 |
| Ethyl diglycol | 7.50 |
| Dowanol DPM ™ | 1.0 |
| Michem emulsion 39235 ™ | 8.5 |
| Tributoxyethylphosphate | 1.50 |
| QW 24 ™ | 43.235 |
| TOTAL | 182.0 |

QW 24 ™ is a aqueous urethane polymer dispersion.

TABLE VI
Part B

| Ingredient | Amount (kg) |
|---|---|
| Dianal BR115 ™ | 15.0 |
| Butyl Acetate | 85.0 |
| Total | 100.0 |

Dianal BR-115 ™ is a crystalline poly (methyl methacrylate) resin.

The final floor coating composition was prepared by blending the 4.0 g of the 15% Dianal BR115™ in butyl acetate—Part B—(refer Table VI) into 182 grams of Part A (refer Table V) to produce a homogeneous floor coating composition.

The blending involved the slow addition of the solution of Table V to the agitated composition of Table VI at room temperature with moderate shear for 30 minutes, allowing it to stand for 2 hours before use.

Five coats of the formulation were applied to vinyl flooring according to commercial practice. The finished product was uniform, with a fine rough appearance.

### EXAMPLE 4

4%, of a 15% of a poly(methyl methacrylate) resin in butyl acetate (as given in Table VI), was added to a typical commercially available floor polish having a formulation as set out in the Table VII.

TABLE VII

| Ingredient | Weight (gm) |
|---|---|
| Water | 33.60 |
| Kathon CG ™ | 0.06 |
| Zonyl FSA ™ | 0.92 |
| Antifoam 9022 | 0.05 |
| Diethylene glycol ethyl ether | 7.51 |
| Dowanol DPM ™ | 0.82 |
| Tributoxy ethyl phosphate | 1.44 |
| Base polymer | 43.22 |
| Michem emulsion 39235 ™ | 8.60 |

The composition produced was homogeneous, It initially seemed similar in appearance to conventional floor coatings and polishes. However, upon drying, unlike conventional floor coatings, it developed uniform crystallites across the dried sealer surface. The surface coating was found to be extremely uniform in appearance and roughness of texture (ie having a high CoF (Coefficient of Friction), making it ideal as an anti-slip floor finish for wet or dry conditions.

### EXAMPLE 5

Compositions were prepared using different base polymeric materials (as set out in Table VIII) together with the ingredients typically found in commercially available floor polishes, as in Example 4. Poly(methyl methacrylate) resin in butyl acetate was added to these compositions to prepare compositions of the invention. The properties of various formulations given in Table VIII were investigated further, when coated onto vinyl substrates. Properties such as general surface appearance, gloss, contact angles, surface morphology and roughness were determined. (Composition code MK-7-47a is a control formula—ie minus the crystalline polymeric material—for the Duraplus 3L0™ base polymer formulation.)

### A: Appearance and Refractive Index

Table VIII records the base polymeric materials used, the appearance of the final coating, percentage solids and the refractive index.

TABLE VIII

| Composition | Base Polymeric | | | Refractive |
|---|---|---|---|---|
| code | material | Appearance | % Solids | Index |
| MK-7-42 | Urethane | Anti-slip, very fine | 10.61 | 1.3617 |
| | QW24-1 ™ | crystallites(finer | | |
| | | structure), uniform | | |
| | | roughness, dull in | | |
| | | appearance, non scratchable | | |
| MK-7-44 | Rohm & Haas | Anti-slip, very rough | 22.86 | 1.3859 |
| | Duraplus | uniform surface, high slip | | |
| | 3L0 ™ | resistance, surface | | |
| | | extremely glossy | | |
| MK-7-45 | Whiteley W1 | Anti-slip, fine structure, | 21.09 | 1.3823 |
| | | extremely uniform | | |
| | | medium slip resistance, | | |
| | | dull appearance | | |
| MK-7-46a | Esicryl | Only sparingly covered | 19.53 | 1.3776 |
| | 405 ™ + BASF | with crystallites so less | | |
| | Acronal Eco | anti-slip than the other | | |
| | A530 ™ | formulations | | |
| MK-7-46b | BASF Acronal | Anti-slip uniformly | 18.40 | 1.3776 |
| | Eco A530 ™ | covered with crystallites, | | |
| | | high slip resistance, | | |
| | | glossy appearance | | |
| MK-7-47a | Rohm & Haas | Control formulation | 22.69 | 1.3850 |
| | Duraplus | (minus the resin), “Not” | | |
| | 3L0 ™ | anti-slip, surface | | |
| | | extremely smooth, no | | |
| | | slip resistance, non scratchable. | | |
| MK-7-47b | Rohm & Haas | Anti-slip, very uniform | 22.69 | 1.3860 |
| | Duraplus | rough surface highly anti | | |
| | 3L0 ™ | slip. | | |

### B: Gloss Levels

The gloss level of each of the compositions of Example 5, following application to vinyl tiles, was measured. First, the gloss level was measured on the bare tiles and found to be 8.7 (range 11.3). The gloss level was then measured after every application for a given composition. The gloss levels were measured using a BYK Gardner micro-gloss 600 gloss meter. The results obtained are given in Table IX below.

TABLE IX

| | MK-7- | MK-7- | MK-7- | MK-7- | MK-7- | MK-7- | MK-7- |
|---|---|---|---|---|---|---|---|
| Coat | 46a | 46b | 42 | 45 | 47 | 47b | 44 |
| 1 | 24.8 | 42.2 | 29.8 | 34 | 49.5 | 42.9 | 35.75 |
| 2 | 52.1 | 62.3 | 40.7 | 44.9 | 60.8 | 45.3 | 53.35 |
| 3 | 55.7 | 65.2 | 45.8 | 43.3 | 65 | 36.5 | 45.55 |

Compositions MK-7-46a, MK-7-46b, MK-7-42 & MK-7-47 were found to increase in gloss with each additional coat whereas compositions MK-7-45 and MK-7-44 increased with the first two coats then dropped off slightly on the third coat. For MK-7-47b it was found the gloss levels increased with the first two coats then dropped off significantly on the third.

The above investigations showed that the surface structure was greatly influenced by the base polymeric material used, both for the degree of roughness (Coefficient of Friction) and gloss.

### C: Contact Angles

The Contact Angles for milk, distilled water and virgin olive oil were measured on each of the compositions of Example 5. Contact angle investigations give an in-sight into wetting characteristics and surface roughness. These liquids were chosen because (1) they are liquids commonly spilt in a supermarket environment and (2) they liquids cover the range in hydrophobicity/hydrophilicity.

The measured contact angles for the three liquids under investigation varied with the different compositions of Example 5. Some were seen to both hydrophobic (water hating—ie high contact angle with water) and oleophobic (oil hating-high contact angle with oil) (eg MK-7-46a, MK-7-46b) whereas others were seen to be hydrophobic but not oleophobic (MK-7-42, MK-7-44, MK-7-45 & MK-7-47b).

### D: Atomic Force Microscopy

Atomic Force Microscopy (AFM) investigations using a Nanoscope MK11 atomic force microscope were carried out on samples of the compositions of Example 5, These investigations provided an insight into the mechanism involved in crystallite formation which occurs upon drying at the solid/air interface. The investigations also provided valuable information into the differences in final roughness, morphology and coefficient of friction using different base polymers in the composition of the invention.

Samples were prepared by coating the composition of the invention onto 1 cm square vinyl tile substrates.

Composition MK-7-42: From a 1 μm×1 μm scan it could be seen that the coating consisted of fine particles approximately 70 nm in size. At lower magnification (ie scan sizes 5 μm×5 μm to 10 μm×10 μm) it was seen that these particles made up a relatively uniform and smooth surface.

In order to test the hardness of the surface, a localised region (1 μm×1 μm) was scanned at a high force for several minutes and then zooming out (lower magnification) the region was viewed to see if any of the features in that region were altered by the hard force imposed. Upon examination the surface appeared unchanged.

Composition MK-7-45: When scanned over a region of 5×5 μm and 10 μm×10 μm it was apparent the surface was smooth locally but that there were larger particles scattered across the entire surface. On the 1 μm×1 μm scan it was seen that the coating consisted of fine particles approximately 70 nm in size. A second coat was applied to the vinyl tile substrate and examined after 3 hours On comparing the image obtained after two coats with that after one coat they appeared very similar.

When tested for hardness, in a manner similar to that of composition MK-7-42, it was evident that the region in the centre of the scan area was affected by the high force imposed.

Composition MK-7-46a: The coating was imaged approximately 28 hour after application. The 10×10 μm scan appeared very uniform and locally smooth. There were no larger crystallites evident in the scanned region. At higher magnification 5×5 μm scan it is clearly seen the surface was covered by a uniform distribution of particles over the entire surface. However, the crystallites/particles observed were much smaller than found for MK-7-45.

A second coat of formulation MK-7-46a was applied to the vinyl tile substrate and examined 9 days later. The surfaces were scanned over a 10 μm×10 μm and 5 μm×5 μm area. On comparing the image obtained after two coats with that after one coat they appeared very similar only the density of the particles covering the surface appears much greater.

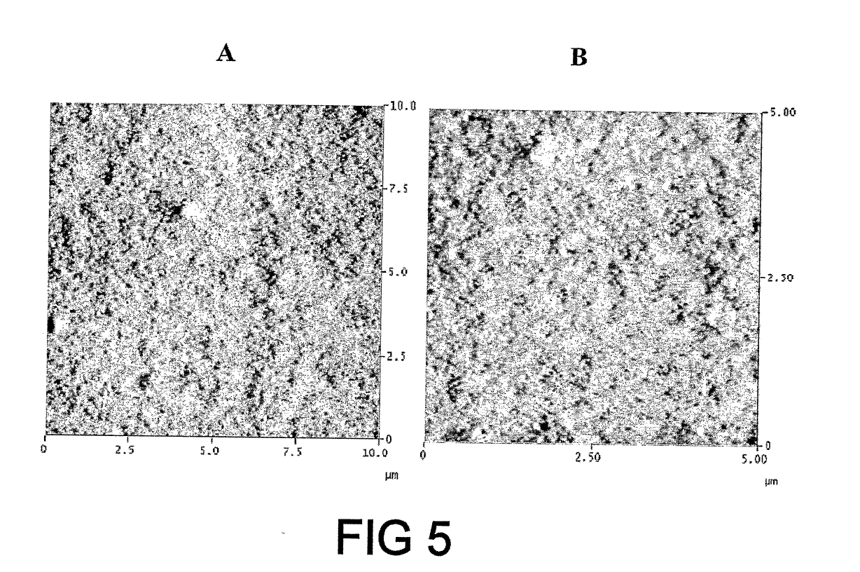

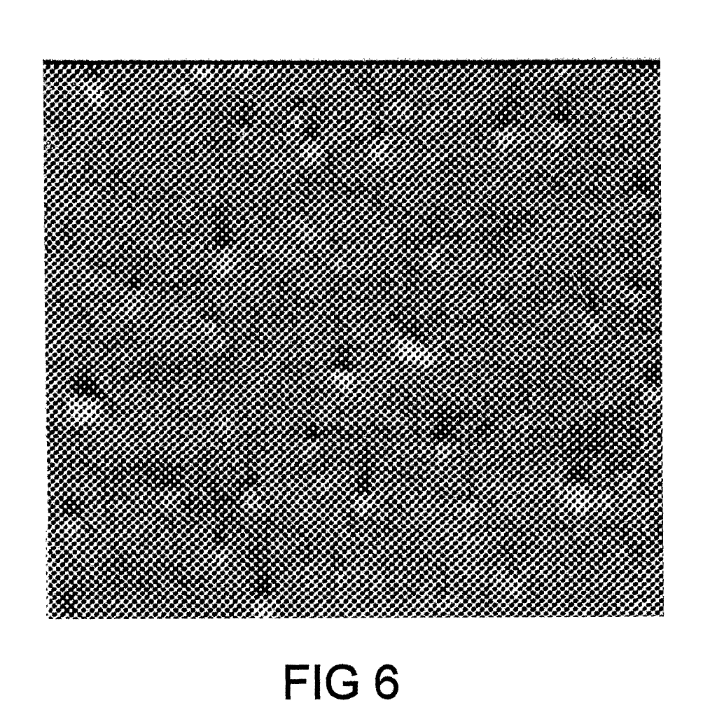

Composition MK-7-47b: A second coat of formulation MK-7-46a was applied to the vinyl tile substrate and examined 9 days later. The surfaces were scanned over a 10 μm×10 μm and 5 μm×5 μm area. There were well spaced particles or crystallites (0.9-1.1 micron) spread out across the entire surface. FIG. 5A shows the AFM image of composition MK-7-47b after the second coat was applied to the vinyl tile substrate over scan area 10 μm×10 μm. FIG. 5B shows the AFM image of composition MK-7-47b after the second coat was applied to the vinyl tile substrate over scan area 5 μm×5 μm. FIG. 6 shows the image of FIG. 5B, enlarged. These FIGS. 5A, 5B and 6 show the spread of crystals over the entire surface.

### E: Surface Roughness

Surface roughness of some of the Example 5 compositions was determined using AFM. The compositions of the invention were cast onto vinyl tile substrates. The cast films were then allowed to dry and then the surface scanned over a region 100 μm×100 μm in air. Images were collected and analysed by the surface roughness software on the Nanoscope MKII after image flattening. The results are set out in Table X.

TABLE X

| Composition Code | Maximum Roughness (μm) |
|---|---|
| MK-7-44 Duraplus 3L0 ™ | 1.454 |
| MK-7-47 Duraplus 3L0 ™ | 1.321 |
| MK-7-46b Acronal Eco A530 ™ | 4.526 |

### F: Investigations Using Light Microscopy

Light microscopy investigations were undertaken by which the surface morphology could be visualised and which therefore allowed understanding of the nature of the anti-slip surface. Several of the Example 5 compositions were investigated.

Black vinyl floor tiles (30 cm×30 cm) were coated with 3 coats of the composition of the invention. Using a light microscope fitted with a digital camera the surface of each composition was examined.

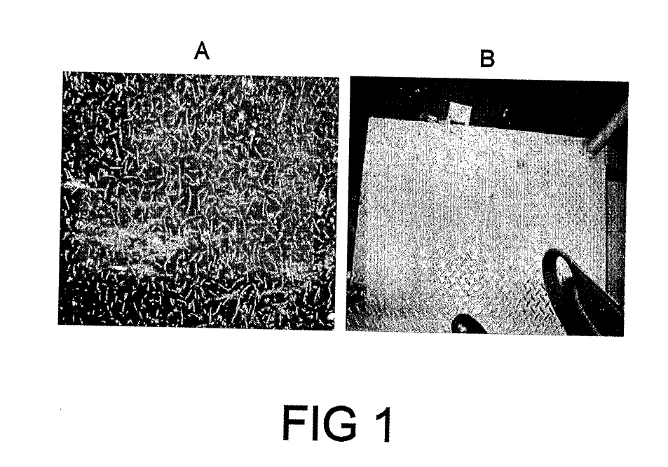

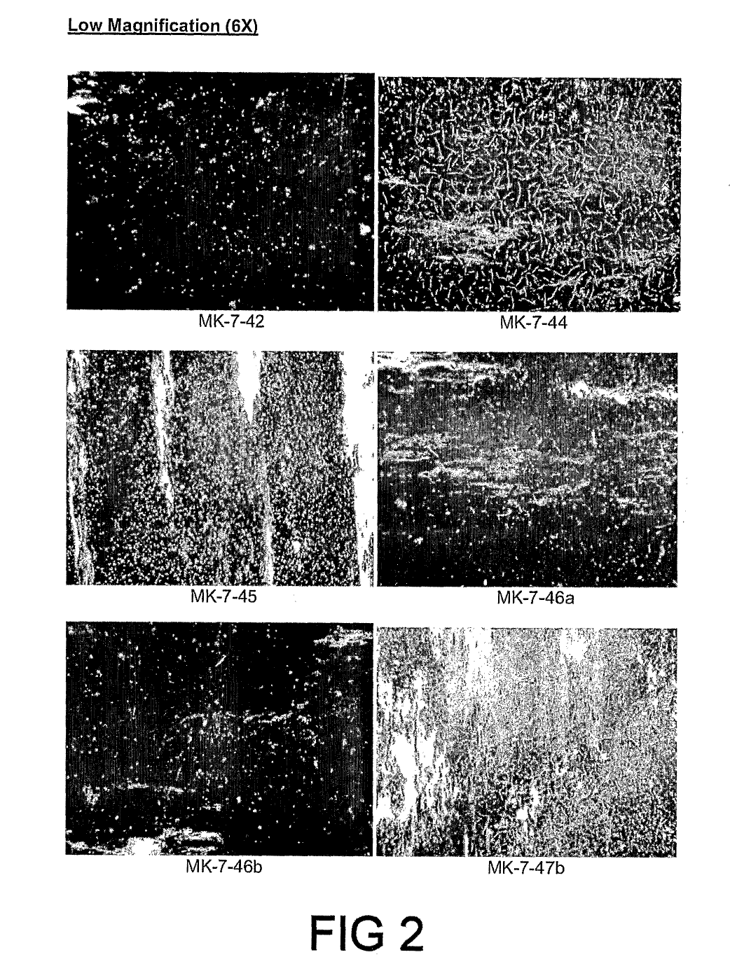

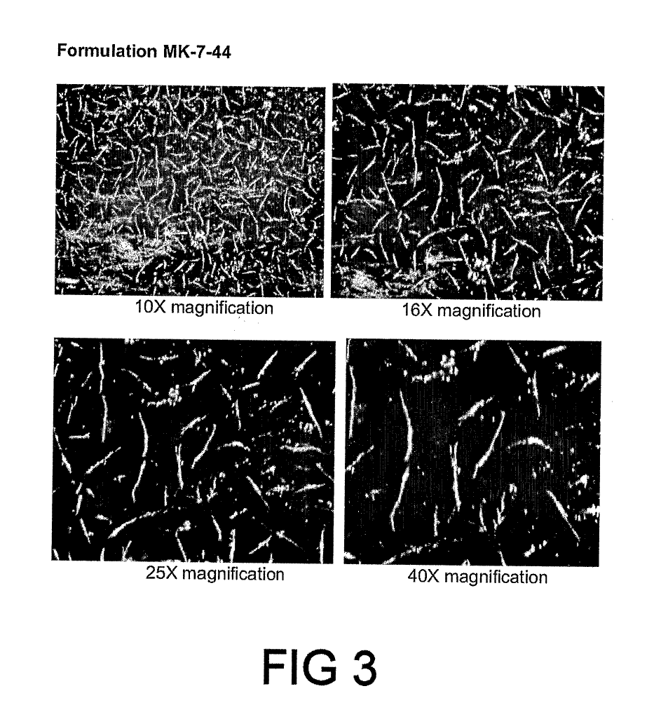

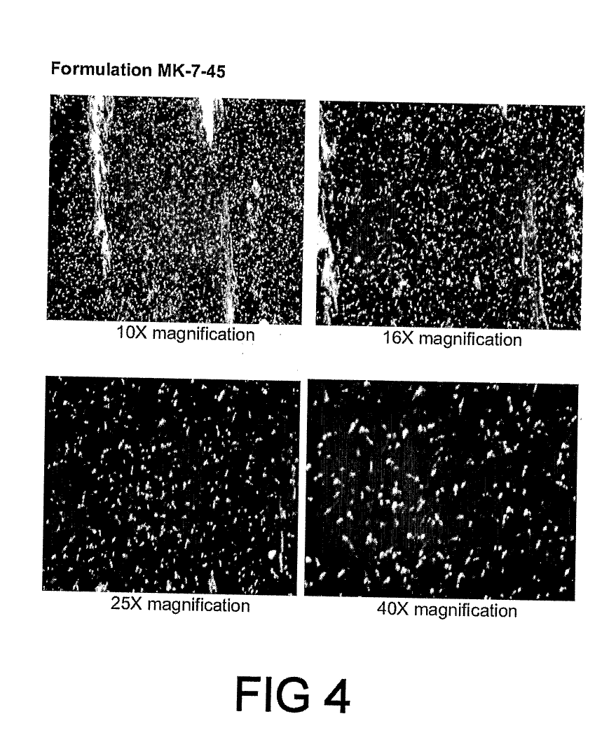

When the coated surfaces were examined under a light microscope a large difference in roughness and size of crystallite was noticed depending on the base polymeric material used in the composition. The crystallites formed in-situ upon drying varied from spherical particles to raised polymer strands (refer FIGS. 1-4). It is interesting that the patterning achieved upon the drying of composition MK-7-44 looked similar to that of patterned metal work used to prevent slips and falls (refer FIG. 1).

The tiles coated with the composition of the invention had a uniform raised patterning across the entire coated surface, thus increasing the surface roughness and therefore the coefficient of friction (CoF). The high coefficient of friction resulted from unique polymer strands forming at the air/water interface (ie surface of the substrate) upon drying. Because the composition of the invention is homogeneous, on application, the resultant patterning is uniformly distributed over the entire surface on drying. As each additional coat is applied, the frequency of crystallite formation is increased, which means the distance between the raised patterning decreases, which would result in greater slip resistance.

### EXAMPLE 6

The addition of Dianal BR115™ in Butyl acetate to existing commercial polishes on the market was investigated. 4% of a 15% Dianal BR115™ in butyl acetate was added to samples of Avmor sealers—“Profile plus”, “Venture”, “Quantum” and “Distance”. The results showed that a solution of a crystalline polymeric material in a solvent can be added to an existing floor coating composition to improve the anti-slip properties.

### EXAMPLE 7

The compositions of Examples 1-6 are all “strippable”. Under some circumstances it may be beneficial to have a more permanent sealer which does not require regular stripping for maintenance. Hence, a “non-strippable” floor coating according to the invention was prepared. The formulation is as set out in Table XI

TABLE XI

| Ingredient | w/w (1000 kg batch) |
|---|---|
| Water | 359.3 |
| QW24 ™ | 492.4 |
| Primal 2133 ™ | 98.50 |
| Dispclair CF 904 ™ | 0.50 |
| Zonyl FSA ™ | 0.10 |
| MDI ™ Methyl diglycol | 49.20 |
| 15% Dianal BR115 ™ in | 41.70 |
| butyl acetate | |

The product was painted onto black vinyl tiles and examined for gloss and general appearance. It was found that the surface had a fine texture and was anti-slip. The gloss level after 3 coats was found to be 57.1 (range 11.7).

### EXAMPLE 8

Product Stability: Samples of composition of the invention which were prepared 12 months earlier were found to be homogeneous. When applied to vinyl tiles they dried to a glossy rough surface similar in appearance to what was found upon initial preparation, indicating that the compositions are stable, and that the anti-slip nature is not adversely effected on storage.

Other combinations, variations and manufacturing procedures will be discernable by those experienced in the relative area of synthetic resin technology.

1. An aqueous based floor coating composition including a base polymeric material, a crystalline polymeric material, a surfactant, and a solvent for the crystalline polymeric material, wherein the crystalline polymeric material is dissolved in the composition and recrystallises within the coating on drying.

2. An aqueous based floor coating composition according to claim 1 wherein the composition includes an additive selected from the group consisting of biocides, defoamers, plasticizers, surfactants, wax emulsions, brightening agents, fragrances, buffing agents, polar coalescing agents, stabilisers, polyethylene and polypropylene waxes, odour suppressers and soil resistance agents.

3. An aqueous based floor coating composition according to claim 1 wherein the base polymeric material is formed from polymerisation of ethylenically unsaturated monomers.

4. An aqueous based floor coating composition according claim 1 wherein the base polymeric material is selected from the group consisting of an acrylic, modified acrylic, urethane, styrene, alkylstyrene, stilbene polymer or copolymer, and mixtures thereof.

5. An aqueous based floor coating according to claim 4 wherein the acrylic polymer or acrylic copolymer is derived from polymerization of one or more monomer units selected from the group consisting of methyl methacrylate, methyl acrylate, hydroxy methyl acrylate, hydroxy ethyl acrylate, ethyl acrylate, propyl acrylate, hydroxy propyl acrylate, butyl acrylate, isopropyl acrylate, isobutyl acrylate, acrylic acid, methacrylic acid, phosphoethyl acrylate, 2 ethyl hexyl acrylate, and styrene and other derivatives thereof.

6. An aqueous based floor coating composition according to claim 4 wherein the acrylic polymer or acrylic copolymer is cross-linked.

7. An aqueous based floor coating composition according to claim 1 wherein the base polymeric material is present in an amount of from 2 to 90 wt % of the weight of the aqueous based floor coating composition.

8. An aqueous based floor coating composition according to claim 7 wherein the base polymeric material is present in an amount of from 5 to 60 wt % of the weight of the aqueous based floor coating composition.

9. An aqueous based floor coating composition according to claim 8 wherein to the base polymeric material is present in an amount of from 10 to 50 wt % of the weight of the aqueous based floor coating composition.

10. An aqueous based floor coating composition according to claim 9 wherein the base polymeric material is present in an amount of from 20 to 40 wt % of the weight of the aqueous based floor composition.

11. An aqueous based floor coating composition according to claim 1 wherein the crystalline polymeric material is selected from the group consisting of acrylic polymers, methylate polymers, poly acrylic polymers, epoxy polymers, polycarbonate polymers, polyester polymers, polystyrene polymers, poly vinyl polymers, and polyurethanes, or composites, derivatives or graft copolymers thereof.

12. An aqueous based floor coating composition according to claim 11 wherein the crystalline polymeric material has a molecular weight in the range of about 1000 to 200 000.

13. An aqueous based floor coating composition according to claim 12 wherein the crystalline polymeric material has a molecular weight of about 50 000.

14. An aqueous based floor coating composition according to claim 11 wherein the crystalline polymeric material is selected from the group consisting of poly(methyl methacrylate), polycarbonate, poly acrylic, polystyrene and polyurethane polymers.

15. An aqueous based floor coating composition according to claim 1 wherein the crystalline polymeric material is present in an amount of from 0.1 to 20 wt % based on the weight of the aqueous based floor coating composition.

16. An aqueous based floor coating composition according to claim 15 wherein the crystalline polymeric material is present in an amount of from 1 to 10 wt % based on the weight of the aqueous based floor coating composition.

17. An aqueous based floor coating composition according to claim 1 wherein the solvent for the crystalline polymeric material is an organic solvent.

18. An aqueous based floor coating composition according to claim 17 wherein the organic solvent is selected from the group consisting of methyl acetate, ethyl acetate, propyl acetate, isopropyl acetate, butyl acetate, pentyl acetate, butanol, hexanol, hexyl acetate; cyclohexanol, n-methylpyrrolidone, pyrrolidone, cyclohexanone, cyclohexyl acetate, benzyl alcohol, benzaldehyde, benzyl acetate, dichlorobenzylalcohol; ethylene glycol; propyl, butyl and hexyl mono and diglycols and their methyl, ethyl esters and acetates; methyl, ethyl and propyl lactate and citrates; phthalate methyl, ethyl and butyl esters, tributyl ethoxy phosphate; dipentene, terpineol; methyl ketone, amyl ketone, di isobutyl ketone, amyl acetate, isobutyl acrylate and tetrahydrofuran, and mixtures thereof.

19. An aqueous based floor coating composition according to claim 1 wherein the solvent for the crystalline polymeric material is present in an amount of from 0.5 to 20 wt % of the weight of the aqueous based floor coating composition.

20. A method of making an aqueous based floor coating composition comprising the steps of:
(a) providing an emulsion of a base polymeric material in water;
(b) dissolving a crystalline polymeric material in a solvent for the crystalline polymeric material to provide a solution of the crystalline polymeric material;
(c) mixing the solution of crystalline polymeric material produced in step (b) with the emulsion of base polymeric material provided in step (a), wherein the mixing is conducted for a period of time and in a manner to produce a homogeneous composition.

21. A method according to claim 20 wherein the base polymeric material is formed from polymerisation of ethylenically unsaturated monomers.

22. A method according to claim 20 wherein the base polymeric material is selected from the group consisting of an acrylic, modified acrylic, urethane, styrene, alkylstyrene, stilbene polymer or copolymer, and mixtures thereof.

23. A method according to claim 22 wherein the acrylic polymer or acrylic copolymer is derived from polymerization of one or more monomer units selected from the group consisting of methyl methacrylate, methyl acrylate, hydroxy methyl acrylate, hydroxy ethyl acrylate, ethyl acrylate, propyl acrylate, hydroxy propyl acrylate, butyl acrylate, isopropyl acrylate, isobutyl acrylate, acrylic acid, methacrylic acid, phosphoethyl acrylate and 2 ethyl hexyl acrylate, styrene and other derivatives thereof.

24. A method according to claim 22 wherein the acrylic polymer or acrylic copolymer is cross-linked.

25. A method according to according to claim 20 wherein the base polymeric material is present in an amount of from 2 to 90 wt % of the weight of the aqueous based floor coating composition.

26. A method according to according to claim 20 wherein the base polymeric material is present in an amount of from 5 to 60 wt % of the weight of the aqueous based floor coating composition.

27. A method according to claim 26 wherein the base polymeric material is present in an amount of from 10 to 50 wt % of the weight of the aqueous based floor coating composition.

28. A method according to claim 27 wherein the base polymeric material is present in an amount of from 20 to 40 wt % of the weight of the aqueous based floor coating composition.

29. A method according to claim 20 wherein the crystalline polymeric material is selected from the group consisting of acrylic polymers, methylate polymers, poly acrylic polymers, epoxy polymers, polycarbonate polymers, polyester polymers, polystyrene polymers, poly vinyl polymers, and polyurethanes, or composites, derivatives or graft copolymers thereof.

30. A method according to claim 29 wherein the crystalline polymeric material has a molecular weight in the range of about 1000 to 200 000.

31. A method according to claim 30 wherein the crystalline polymeric material has a molecular weight of about 50 000.

32. A method according to claim 29 wherein the crystalline polymeric material is selected from the group consisting of poly(methyl methacrylate), polycarbonate, poly acrylic, polystyrene and polyurethane polymers.

33. A method according to claim 20 wherein the crystalline polymeric material is present in an amount of from 0.1 to 20 wt % based on the weight of the aqueous based floor coating composition.

34. A method according to claim 20 wherein the crystalline polymeric material is present in an amount of from 1 to 10 wt % based on the weight of the aqueous based floor composition.

35. A method according to claim 20 wherein the solvent for the crystalline polymeric material is an organic solvent.

36. A method according to claim 35 wherein the organic solvent is selected from the group consisting of methyl acetate, ethyl acetate, propyl acetate, isopropyl acetate, butyl acetate, pentyl acetate, butanol, hexanol, hexyl acetate; cyclohexanol, n-methylpyrrolidone, pyrrolidone, cyclohexanone, cyclohexyl acetate, benzyl alcohol, benzaldehyde, benzyl acetate, dichlorobenzylalcohol; ethylene glycol; propyl, butyl and hexyl mono and diglycols and their methyl, ethyl esters and acetates; methyl, ethyl and propyl lactate and citrates; phthalate methyl, ethyl and butyl esters, tributyl ethoxy phosphate; dipentene, terpineol; methyl ketone, amyl ketone, di isobutyl ketone, amyl acetate, isobutyl acrylate and tetrahydrofuran.

37. A method according to claim 20 wherein the solvent is present in an amount of from 0.5 to 20 wt % of the weight of the aqueous based floor coating composition.

38. (canceled)

39. A method of improving the anti-slip properties of a floor coating composition, which method includes mixing a solution of a crystalline polymeric material in a solvent with the floor coating composition.

40. A method according to claim 39 wherein the crystalline polymeric material is selected from the group consisting of acrylic polymers, methylate polymers, poly acrylic polymers, epoxy polymers, polycarbonate polymers, polyester polymers, polystyrene polymers, poly vinyl polymers, and polyurethanes, or composites, derivatives or graft copolymers thereof.

41. A method according to claim 39 wherein the crystalline polymeric material has a molecular weight in the range of about 1000 to 200 000.

42. A method according to claim 41 wherein the crystalline polymeric material has a molecular weight of about 50 000.

43. A method according to claim 39 wherein the crystalline polymeric material is selected from the group consisting of poly(methyl methacrylate), polycarbonate, poly acrylic, polystyrene and polyurethane polymers.

44. A method according to claim 39 wherein the crystalline polymeric material is present in an amount of from 0.1 to 20 wt % based on the weight of the aqueous based floor coating composition.

45. A method according to claim 44 wherein the crystalline polymeric material is present in an amount of from 1 to 10 wt % based on the weight of the aqueous based floor composition.

46. A method according to claim 39 wherein the solvent for the crystalline polymeric material is an organic solvent.

47. A method according to claim 46 wherein the organic solvent is selected from the group consisting of methyl acetate, ethyl acetate, propyl acetate, isopropyl acetate, butyl acetate, pentyl acetate, butanol, hexanol, hexyl acetate; cyclohexanol, n-methylpyrrolidone, pyrrolidone, cyclohexanone, cyclohexyl acetate, benzyl alcohol, benzaldehyde, benzyl acetate, dichlorobenzylalcohol; ethylene glycol; propyl, butyl and hexyl mono and diglycols and their methyl, ethyl esters and acetates; methyl, ethyl and propyl lactate and citrates; phthalate methyl, ethyl and butyl esters, tributyl ethoxy phosphate; dipentene, terpineol; methyl ketone, amyl ketone, di isobutyl ketone, amyl acetate, isobutyl acrylate and tetrahydrofuran.

48. A method of improving anti-slip properties of a surface by applying to said surface an aqueous based coating composition including a base polymeric material, a crystalline polymeric material, a surfactant, and a solvent for the crystalline polymeric material, wherein the crystalline polymeric material is dissolved in the composition and recrystallises within the coating on drying.

49. A method according to claim 48 wherein the surface is selected from a high traffic surface, handling surface, tire surface, marine surface, surf board surface, air traffic surface, aircraft surface, automotive surfaces, footware surface and leather goods surface.

50. (canceled)
